(19) United States
(12) Patent Application Publication
(10) Pub. No.: US 2020/0293033 A1
(43) Pub. Date: Sep. 17, 2020

(54) KNOWLEDGE-BASED SYSTEMATIC HEALTH MONITORING SYSTEM

(71) Applicant: General Electric Company, Schenectady, NY (US)

(72) Inventors: Lijun HE, Schnectady, NY (US); Honggang WANG, Clifton Park, NY (US); Weizhong YAN, Clifton Park, NY (US); Liwei HAO, Niskayuna, NY (US)

(21) Appl. No.: 16/562,641

(22) Filed: Sep. 6, 2019

Related U.S. Application Data
(60) Provisional application No. 62/817,956, filed on Mar. 13, 2019.

(51) Int. Cl. G05B 23/02; G05B 15/02; H02J 13/00

(52) U.S. Cl. CPC G05B 23/0208; H02J 13/0017; G05B 15/02

(57) ABSTRACT

Briefly, embodiments are directed to a system, method, and article for monitoring health of a power system. Input data may be received from one or more sources, where the input data comprises at least measurements of one or more power system assets from one or more phasor measurement units (PMUs). An anomaly may be detected within the power system based on the input data. A determination may be made as to whether the anomaly comprises an asset anomaly of the one or more power system assets. In response to determining that the anomaly comprises an asset anomaly, a characterization may be made as to whether the asset anomaly comprises an equipment anomaly or a sensor anomaly and an alert may be generated to indicate whether the asset anomaly comprises the equipment anomaly or the sensor anomaly based on the characterization.

### CROSS-REFERENCE TO RELATED APPLICATIONS

The present application claims the benefit of U.S. Provisional Patent Application No. 62/817,956 entitled “EXTREMELY FAST SUBSTATION ASSET MONITORING” and filed on Mar. 13, 2019. The entire content of that application is incorporated herein by reference.

### BACKGROUND

A power grid or electrical grid is an interconnected network for delivering electricity from producers to consumers. A power grid typically contains various pieces of equipment or assets. For example, a power system may include one or more generators, one or more substations, power transmission lines, and power distribution lines. A generator or generating station may generate electric power from sources of primary energy or may convert motive power into electrical power for transmission to a power electrical grid. A substation may be a part of an electrical generation, transmission, and distribution system. Substations may transform voltage from high to low, or the reverse, or perform any of several other functions. Between a generating station and consumer, electric power may flow through several substations at different voltage levels. A substation may include transformers to change voltage levels between high transmission voltages and lower distribution voltages, or at the interconnection of two different transmission voltages. Electric power transmission lines may facilitate bulk movement of electrical energy from a generating site, such as a power plant comprising one or more generators, to one or more electrical substations. The interconnected lines which facilitate this movement are known as a transmission network. Electric power distribution is the final stage in the delivery of electric power; it carries electricity from the transmission system to individual consumers. Distribution substations connect to the transmission system and lower the transmission voltage to medium voltage through the use of transformers. Primary distribution lines carry this medium voltage power to distribution transformers located near the customer's premises. Distribution transformers again lower the voltage to the utilization voltage used by lighting, industrial equipment or household appliances. Often several customers are supplied from one transformer through secondary distribution lines. Commercial and residential customers are connected to the secondary distribution lines through service drops.

There are various pieces of equipment within a power grid may become damaged or which may otherwise malfunction over time, which may potentially lead to downtime for the power grid or a portion of the power grid. Current asset monitoring systems monitor individual assets, such as individual items of equipment, but are unable to perform system-level asset health anomaly detection, classification, localization solution for all assets in the power grid.

### SUMMARY

According to an aspect of an example embodiment, a method may monitor a health of a power system. Input data may be received from one or more sources, where the input data comprises at least measurements of one or more power system assets from one or more phasor measurement units (PMUs). An anomaly may be detected within the power system based on the input data. A determination may be made as to whether the anomaly comprises an asset anomaly of the one or more power system assets. In response to determining that the anomaly comprises an asset anomaly, a characterization may be made as to whether the asset anomaly comprises an equipment anomaly or a sensor anomaly and an alert may be generated to indicate whether the asset anomaly comprises the equipment anomaly or the sensor anomaly based on the characterization.

According to an aspect of another example embodiment, a system may include a receiver to receive input data from one or more sources. The input data may comprise at least measurements of one or more power system assets from one or more PMUs. A processor may detect an anomaly within the power system based on the input data and may determine whether the anomaly comprises an asset anomaly of the one or more power system assets. In response to a determination that the anomaly comprises an asset anomaly, the asset anomaly may be characterized as comprising an equipment anomaly or a sensor anomaly, and an alert may be generated to indicate whether the asset anomaly comprises the equipment anomaly or the sensor anomaly based on the characterization.

According to an aspect of another example embodiment, an article may comprise a non-transitory storage medium comprising machine-readable instructions executable by one or more processors. The instructions may be executable to access input data from one or more sources, where the input data comprises at least measurements of one or more power system assets from one or more PMUs. The instructions may be further executable by the processor to detect an anomaly within the power system based on the input data and determine whether the anomaly comprises an asset anomaly of the one or more power system assets. In response to a determination that the anomaly comprises an asset anomaly, the asset anomaly may be characterized as comprising an equipment anomaly or a sensor anomaly, and an alert may be generated to indicate whether the asset anomaly comprises the equipment anomaly or the sensor anomaly based on the characterization.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a power distribution grid.

FIG. 2 illustrates an embodiment of an Asset Health Monitoring (AHM) System.

FIG. 3 illustrates an embodiment of a system for monitoring interactions between substation A and a power grid.

FIG. 4 is an embodiment of a flowchart of a process for determining asset health management of one or more power system assets.

FIG. 5 illustrates an embodiment of a system for monitoring interactions between generator A, substation A, and a power grid.

FIG. 6 illustrates a power grid system including an AHM module in accordance with an example embodiment.

FIG. 7 illustrates an AHM server according to an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments, as discussed herein, comprise a system and/or method for using knowledge-based asset health monitoring (AHM) system or solution to systematically detect, classify, localize various disturbance events in the entire power grid, distinguish asset anomalies (e.g., sensors and equipment anomalies) from grid anomaly event (e.g., generator loss, line faults/trips, or intra-area/inter-area oscillation). Such a system in accordance with one or more embodiments may provide a holistic health monitoring solution for electric assets in a power grid via data from various sources, such as Phasor Measurement Unit (PMU) data, Supervisory Control and Data Acquisition (SCADA) data, weather data, and/or network topology data.

High voltage power transformers are one of the most critical assets or items of equipment in the electric power grid. A sudden failure of a power transformer may significantly disrupt bulk power delivery. Before a transformer reaches its critical failure state, there are indicators which, if monitored periodically, may alert an operator that the transformer is heading towards a failure.

A power grid is a critical component of infrastructures as other components of the infrastructure, such as communication, transportation and finance are heavily dependent upon the power grid. Similarly, high voltage (HV) power transformers, generators, and transmission lines are critical components of the electric power grid. Therefore, an untimely loss of HV transformers may be catastrophic for not only the electrical infrastructure, but also the other critical infrastructures which depend on those HV transformers. Accordingly, it would be beneficial to recognize or identify when a transformer is heading towards a failure, before the transformer actually fails, so that corrective measures may be undertaken. Fortunately, before a transformer reaches a critical failure state, there are “cues” (or indicators) which, if monitored periodically, may alert an operator that the transformer is heading towards the failure.

A “Phasor Measurement Unit” or “PMU,” as used herein, refers to a device used to estimate the magnitude and phase angle of an electrical phasor quantity (such as voltage or current) in a power grid using a common time source for synchronization. Time synchronization may be provided by Global Positioning System (GPS) coordinates and may allow for synchronized real-time measurements of multiple remote points on an electricity grid. PMUs may be capable of capturing samples from a waveform in quick succession and reconstructing a phasor quantity, made up of an angle measurement and a magnitude measurement, for example. A resulting measurement is known as a “synchrophasor.” Such time synchronized measurements may be monitored, for example, because if a power grid's supply and demand are not perfectly matched, frequency imbalances may cause stress on the power grid, potentially resulting in power outages.

PMUs may also be used to measure a frequency in a power grid. A typical commercial PMU may report measurements with very high temporal resolution in the order of 30-60 measurements per second, for example. Such measurements may assist engineers in analyzing dynamic events in the power grid which may not be possible with traditional Supervisory Control and Data Acquisition (SCADA) measurements which generate one measurement every 2 or 4 seconds. PMUs may therefore equip utilities with enhanced monitoring and control capabilities and are considered to be one of important measuring devices in the future of power systems. A system may include one or more receivers or transceivers, for example, to receive signals comprising measurements or parameters from one or more PMUs.

One or more embodiments, as discussed herein, present a system and method for a PMU knowledge-based systematic asset health monitoring system. The system may detect anomalies based on input data, including PMU data. The system may include a module to classify whether a detected anomaly comprises a grid anomaly or an asset anomaly and where the anomaly occurs. A module may classify an asset anomaly as an equipment anomaly or a sensor anomaly. A module may classify equipment pre-failure or equipment malfunction. Another module may classify a sensor anomaly as a sensor pre-failure or sensor drifting anomaly.

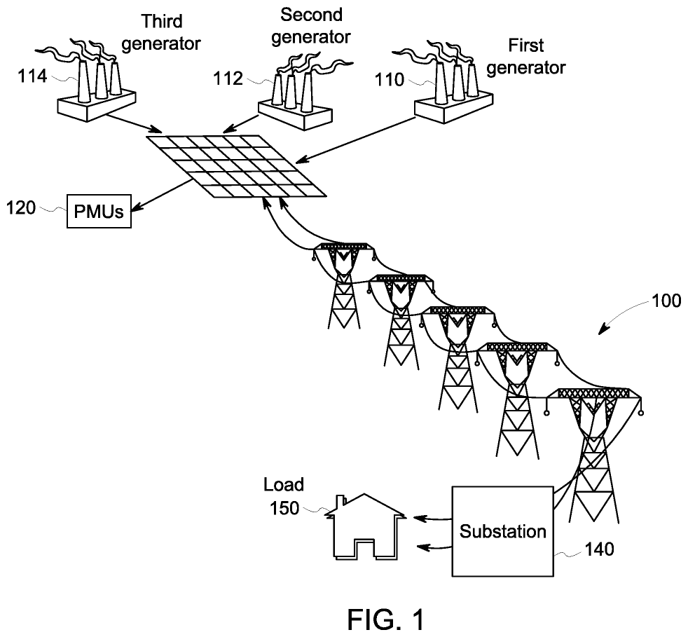

FIG. 1 illustrates an embodiment 100 of a power distribution grid. The grid of embodiment 100 may include a number of components, such as one or more power generators, for example, a first generator 110, second generator 112, and/or third generator 114. Although only three generators are shown in FIG. 1, it should be appreciated that more or fewer than three generators may be utilized in accordance with an embodiment. The grid of embodiment 100 may include transmission networks, transmitting electrons from power generator to one or more substations, such as substation 140, and distribution networks to various loads or users. In embodiment 100, for example, electrons may be transmitted from substation 140 to various loads, such as load 150. Although only a single substation 140 is illustrated in FIG. 1, it should be appreciated that numerous substations may be included in some embodiments, such as where electric power is transmitted from one or more generators to different geographically dispersed loads, for example. Similarly, although only a single load 150 is illustrated in FIG. 1, multiple loads may be included in some embodiments, where the multiple loads draw power from the power distribution grid in accordance with an embodiment.

There are numerous assets located within or along the power distribution grid, between one or more generators, such as first generator 110, and load 150. An “asset” or “electrical asset,” as used herein, refers to an item, such as one or more components of equipment, involved in generation and/or transmission of electrical power between one or more generators and one or more loads or consumers of the electrical power. Assets may include items such as transformers, generators, transmission lines, distribution lines, capacitor banks, circuit breakers, surge arresters, as well as instrument sensors such as current transformer (CT), voltage transformer (VT), capacitor voltage transformer (CVT/CCVT). Assets may be classified as two categories, equipment and sensor. “Equipment” or “equipment assets,” as used herein, refers to an asset, the operation of which directly affects the power flow of a power grid, transformers, generators, transmission lines, distribution lines, capacitor banks, circuit breakers, and/or surge arresters. “Sensor” or “sensor asset,” as used herein, refers to an asset which is used for measuring various power grid quantities (e.g., voltage and current), and which presents a negligible load to the power grid/power system, e.g. CT, VT, or CCVT/CVT.

If any of the equipment becomes damaged or otherwise malfunctions, a portion of the power grid may become at least temporarily inoperable, partially or fully. For example, if one or more transformers becomes damaged, there is a potential for malfunction of a portion of the power distribution grid, which may result in at least a temporary partial power blackout.

If any sensor is damaged or otherwise malfunctions, such as CT, VT, Cor VT/CCVT, the power grid may not be working properly (e.g., mis-operations in relays may result), or power grid may be still operating properly but with inaccurate readings.

One or more embodiments, as discussed herein, are directed to a knowledge-based asset health monitoring system which may detect, classify, and localize disturbance events in the entire power grid and may distinguish between asset anomalies and grid anomaly events to provide a holistic health monitoring solution.

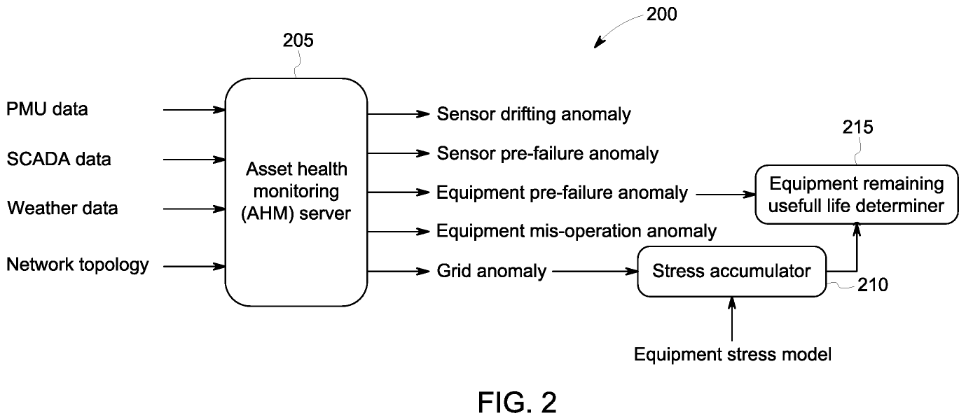

FIG. 2 illustrates an embodiment 200 of an Asset Health Monitoring (AHM) System. As shown, embodiment 200 may include various components, such as an AHM server 205, a stress accumulator 210, and an equipment remaining useful life (RUL) determiner 215, for example. Although only three components are shown in FIG. 2, it should be appreciated that more or fewer than three components may be included in some embodiments. Inputs to the AHM System may include PMU data, such as PMU-derived spatial and temporal signatures. PMU temporal signatures may include parameters or measurements such as signal-to-noise-ratio (SNR), frequency/damping/magnitude of oscillations in frequency domain, sequence components, minimal volume enclosing ellipse (MVEE) features, cumulative deviation in energy, Teager-Kaiser Energy Operator (TKEO) calculations, statistical features (e.g., range, rate of change, mean, variance, max and min values, etc.) from multi-phases/traces of 3-phase raw voltage/current PMU measurement channels, for example. PMU spatial signatures may illustrate an extracted temporal signature distribution across a power distribution network and may help with event causality and localization.

AHM server 205 may receive data from various sources. For example, AHM server 205 may receive PMU data from one or more PMUs and/or one or more Phasor Data Concentrators (PDCs) which may aggregate PMU data from a plurality of PMUs. AHM server 205 may also receive SCADA data from various components. AHM server 205 may additional receive weather data from a weather server or some other weather data broadcasting or transmission service, for example. SCADA data and weather data may be considered to provide additional information, beyond PMU data, related to grid operation and weather conditions. AHM server 205 may additionally receive network topology data. Network topology data may include information such as regarding a generator/load unit connected at each substation. Weather data may include information such as temperature, wind speed, barometric pressure, for example.

AHM server 205, based on the various received data, may determine the health of one or more assets and/or of the entire power distribution system, for example. AHM server 205 may detect one or more anomalies, such as a sensor drifting anomaly, a sensor pre-failure anomaly, an equipment pre-failure anomaly, an equipment mis-operation anomaly, and/or a grid anomaly, to name just a few examples among many. If a grid anomaly is detected, stress accumulator 210 may receive an identification of the grid anomaly as an input and may implement an equipment stress model to determine a stress value for one or more assets or items of equipment on the power grid. An equipment stress model may comprise a model of stress for a particular asset or item of equipment. For example, an equipment stress model may be utilized or implemented to determine how accumulated stresses affect functionality of an item of equipment, for example. If an equipment pre-failure anomaly is detected, an equipment remaining useful life (RUL) determiner 215 may calculate an RUL for a particular piece of equipment based on a combination of the detection of the equipment pre-failure anomaly and an output of stress accumulator 210.

The output of the AHM System may contain or otherwise indicate various identified anomaly events. The anomaly events may include asset anomalies as well as grid anomalies. Typical asset anomalies may include sensor (e.g. instrument transformer such as CT, VT, or CCVT) issues such as sensor drifting anomalies and/or sensor pre-failure anomalies, as well as equipment-related issues such as equipment pre-failure (e.g., power transformer pre-failure due to bushing) and equipment mis-operation (e.g., single-phase or multi-phase circuit breaker mis-operation). If, on the other hand, an anomaly is identified as grid anomaly by the AHM System, a stress accumulator may be activated to evaluate an impact of the anomaly event on different items of equipment with given equipment stress models. A counting algorithm such as a rain flow counting algorithm may be utilized by a stress accumulator may be utilized. The stress accumulator together with an identification of an equipment pre-failure condition may assist to determine damage and/or life estimation of a selected item of equipment. It should be noted that an anomaly event may comprise a combination of individual anomaly types as mentioned above, such as, e.g., a combination of both equipment pre-failure anomaly and a grid line trip anomaly, such that a knowledge-based AMH is capable of identifying such a combined anomaly.

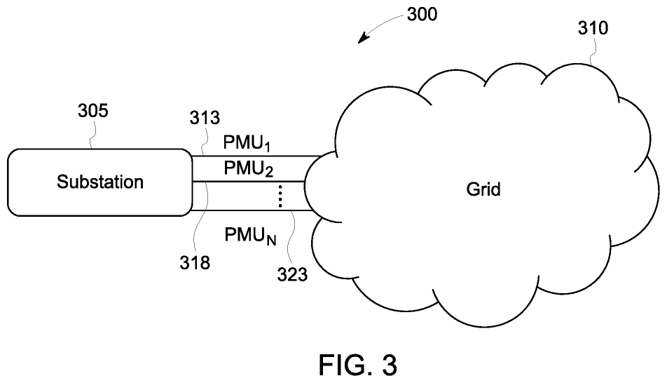

FIG. 3 illustrates an embodiment 300 of a system for monitoring interactions between substation A 305 and a power grid 310. As illustrated, there is no generator or load connected at substation A 305 in embodiment 300. Substation 305 may be connected to grid 310 via various transmission lines, such as transmission lines 313, 318, and 323, for example. A PMU may be installed at substation A 305 which may detect or otherwise generate PMU data. For example, PMU data may be generated for transmissions across transmission line 313, transmission line 318, and/or transmission line 323. Although only three transmission lines are illustrated in FIG. 3, it should be appreciated that in some embodiments, more or fewer than three transmission lines between a substation and a grid may be included.

In accordance with an embodiment, the PMU data may comprise time-stamped voltage and current phasor measurements at the transmission lines connected at the substation. For example, PMU₁ measurements may be made at transmission line 313, PMU₂ measurements may be made at transmission line 318, and PMU_{N} measurements may be made at transmission line 323. The PMU measurements may be transmitted or otherwise provided to a component of an AHM system, such as AHM server 205 illustrated in FIG. 2, for example.

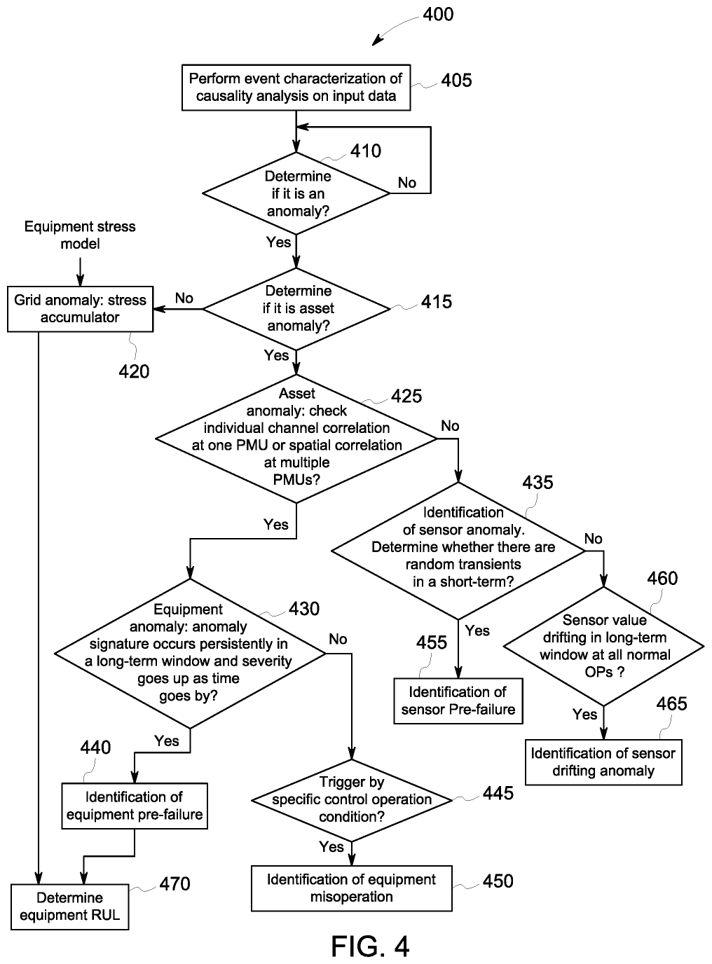

FIG. 4 is an embodiment 400 of a flowchart of a process for determining asset health management of one or more power system assets. At operation 405, event characterization and causality analysis may be performed on input data. For example, the input data may comprise PMU data received from one or more PMU devices, SCADA data from one or more SCADA devices, and weather data from a weather-service service or some other source of weather-related data. Network topology data may also be included in the input data. For example, one or more PMU devices and one or more SCADA devices may be deployed at various locations of a power distribution grid. Weather data may comprise data indicative of weather conditions somewhere along the power distribution grid, for example.

Based, at least partially, on the event characterization and causality analysis, a determination may be made at operation 410 as to whether the input data is indicative of an anomaly. If a determination is made that the input data is not indicative of an anomaly, then processing remains at operation 410. On the other hand, if a determination is made that the input data is indicative of an anomaly, then processing proceeds to operation 415 where a determination may be made as to whether the anomaly comprises an asset anomaly.

One or more processors may perform event characterization and causality analysis at operation 405 and may compare the input data against known signatures of various anomalies to determine whether the input data is indicative or representative of one or more anomalies, such as a grid anomaly or an asset anomaly. An “anomaly,” as used herein, refers to one or more measurements which deviate from expected measurements in some way. For example, an anomaly may be detected if, for example, one or more measurements different from expected measurements by at least 10%. A “grid anomaly,” as used herein, refers to an anomaly affecting operation of a power distribution grid. For example, an occurrence of a line trip may be indicative of a grid anomaly. Additional examples of grid anomalies include generator loss, line faults/trips, and/or intra-area/inter-area oscillation, to name just a few among many. An “asset anomaly,” as used herein, refers to an anomaly detected in measurements of one or more assets of a power distribution grid. For example, an asset anomaly may be detected if an asset is functioning improperly, or if one or more sensors measuring outputs of the asset are functioning improperly.

At operation 415, if it is determined that the anomaly is not an asset anomaly, then it is inferred or otherwise determined that the anomaly is therefore a grid anomaly and processing proceeds to operation 420. At operation 420, a stress accumulator may implement a stress model to calculate a measurement of stress experienced on the power distribution grid. Processing may subsequently proceed to operation 470, where a remaining useful life (RUL) of an asset or item of equipment may be determined, as discussed further below.

Referring back to operation 415, if a determination is made that a detected anomaly does comprise an asset anomaly, then processing may proceed to operation 425, where individual channel correlations at one PMU or spatial correlations at multiple PMUs may be checked. If there is strong correlation between measurements from individual channels, such as between voltage and current of one single phase or among three phase channels of AC voltage (or AC currents) at one point, or the signature can potentially be detected at both the PMU nearest to the asset at the strongest level, as well as nearby PMUs at a reduced severity level—there is correlation between PMUs as different spatial domain, then the disturbance anomaly is related to equipment anomaly. This is because equipment anomaly will cause disturbance on 3-phase power flow in the grid.

If there is no correlation between measurements from individual channels, such as between voltage and current of one single phase or among three phase channels of AC voltage at one point, and the signature can only be detected at 1 PMU with zero correlation with nearby PMUs in space, this may comprise a sensor anomaly

At operation 425, if it is determined the anomaly comprises an equipment anomaly and processing proceeds to operation 430. On the other hand, if it is determined that the anomaly is sensor anomaly, then may proceed to operation 435.

At operation 430, a determination may be made as to whether an anomaly signature occurs persistently in a long-term window and a severity of the anomaly is increasing over time. If “yes” at operation 430, processing proceeds to operation 440 where an identification of equipment pre-failure is made. Typical equipment pre-failure may comprise transformer pre-failure, surge-arrester pre-failure. Different signatures can be used to classify pre-failure anomalies for different equipments. For example, steady growth in the width of SNR bands (computed from voltage magnitude measurements) has been observed over a long period of time until a transformer failed due to transformer bushing failure. The growth was similar in all three phases and strongly correlated. In addition, the signature is not only observed at the nearest PMU to the transformer, it is also observed at nearby PMUs, where the width of the SNR band signature decreases as the distance of the PMU from the transformer increases. Therefore, it is confirmed as an equipment anomaly. Moreover, because the signature persistently occurs during the entire time before final failure, it may be identified as an equipment pre-failure condition. This is further confirmed as transformer pre-failure caused by bushing failure. Processing may subsequently proceed from operation 440 to operation 470, whether a determination of an RUL of an asset or item of equipment may be made with an additional consideration of a calculation from a stress accumulator at operation 420, as discussed above.

Referring back to operation 430, if a determination that a detected anomaly signature does not occur persistently in a long-term window and/or that a severity of the anomaly does not increase over time, processing may proceed to operation 445, where a determination may be made as to whether the equipment anomaly is triggered by a specific control operation condition. If the determination is made that the equipment anomaly is triggered by a specific control operation condition, processing proceeds to operation 450, where an identification of equipment mis-operation may be made. An example is that Phase-A circuit breaker fails to reclose after a command given on all three phase channels of a circuit breaker. Therefore the line voltage on phase A does not go up as the other two phases but slightly decreases, and phase A line current at adjacent transmission line doesn't drop as the other two phases.

Referring back to operation 435, an identification of a sensor anomaly may be made as well as a determination of whether there are random transients in a short-term window. A short-term window may comprise values observed or measured during a relatively short period of time, such as within seconds or several minutes. If there are such transients within a short-term window (such as where a change (variance) or rate of change on a short-term sliding window suddenly goes up), then an identification of a sensor pre-failure may be made at operation 455. An example shows that the SNR of phase C voltage data with random drops is captured days before the actual PT fails. On the other hand, if it is determined that there are not any transients within a short-term window at operation 435, processing may proceed to operation 460, where a determination may be made as to whether there is sensor value drifting within a long-term window at all normal operating parameters. A long-term window may comprise values observed or measured during a relatively long period of time, such as within days or months.

If a determination is made at operation 460 that there is sensor drifting in a long-term window at all normal operating parameters at operation 460, then processing may proceed to operation 465 where an identification of a sensor drifting anomaly may be made.

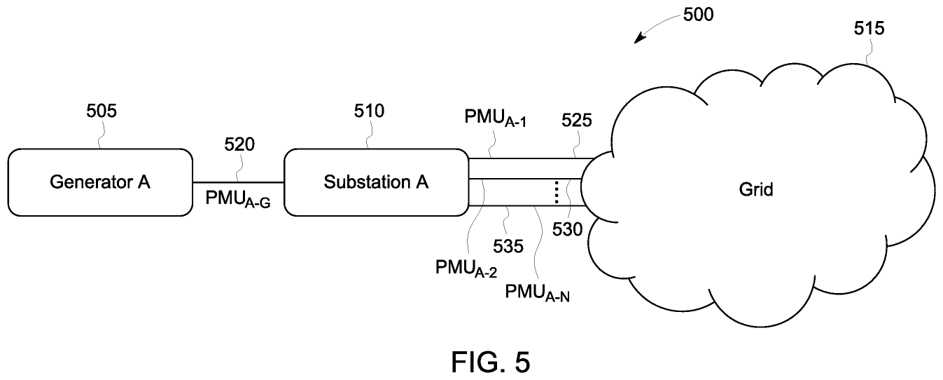

FIG. 5 illustrates an embodiment 500 of a system for monitoring interactions between generator A 505, substation A 510, and a power grid 515. As illustrated, a transmission line 520 may couple generator A 505 to substation A 510. Substation A 510 may be connected to grid 515 via various transmission lines, such as transmission lines 525, 530, and 535, for example. PMUs may be installed at generator A 505 and at substation A to detect or otherwise generator PMU data. For example, PMU data may be generated for transmissions across transmission lines 520, 525, 530, and 535. Although only one transmission line is shown between generator A 505 and substation A 510 and only three transmission lines are shown between substation A 510 and grid 515, it should be appreciated that in some embodiments, a different number of transmission lines may be utilized to couple substation A 510 with generator A 505 and grid 515, for example.

The PMUs may provide time-stamped voltage and current phasor measurements at the transmission lines connected at generator A 505 and at substation A 510. For example, PMU_{A-G} measurements may be made at transmission line 520, PMU_{A-1} measurements may be made at transmission line 525, PMU_{A-2} measurements may be made at transmission line 530, and PMU_{A-N} measurements may be made at transmission line 535. The PMU measurements may be transmitted or otherwise provided to a component of an AHM system, such as AHM server 205 illustrated in FIG. 2, for example.

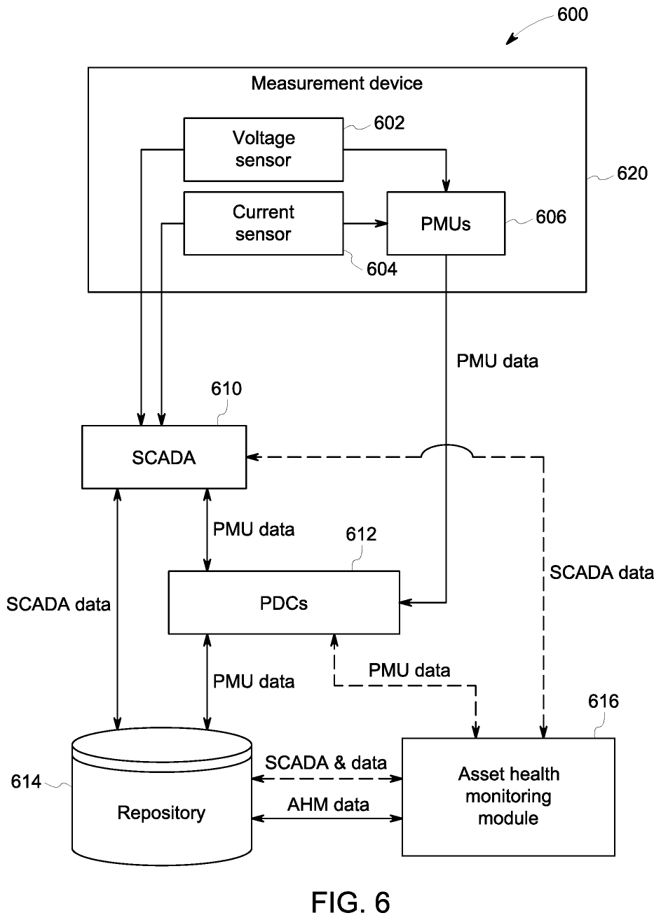

FIG. 6 illustrates a power grid system 600 including an asset health monitoring (AHM) module 616 in accordance with an example embodiment. For example, a server may implement AHM module 616. In this example, the AHM module 616 may monitor the health of one or more assets of a power grid system and/or of the grid itself. In some embodiments, the AHM module 616 may also store and display asset health history for one or more assets and/or of the grid itself and a variety of other statistical information related to disturbances and events, including on a graphical user interface, or in a generated report, for example.

A measurement device 620 shown in FIG. 6 may obtain, monitor or facilitate the determination of electrical characteristics associated with the power grid system (e.g., the electrical power system), which may comprise, for example, power flows, voltage, current, harmonic distortion, frequency, real and reactive power, power factor, fault current, and phase angles. Measurement device 620 may also be associated with a protection relay, a Global Positioning System (GPS), a Phasor Data Concentrator (PDC), communication capabilities, or other functionalities.

Measurement device 620 may provide real-time measurements of electrical characteristics or electrical parameters associated with the power grid system (e.g., the electrical power system). The measurement device 620 may, for example, repeatedly obtain measurements from the power grid system which may be used by the AHM module 616. The data generated or obtained by the measurement device 620 may comprise coded data (e.g., encoded data) associated with the power grid system that may input (or be fed into) a traditional SCADA system. Measurement device 620 may also comprise one or more PMUs 606 which may repeatedly obtain subs-second measurements (e.g., 30 times per second). Here, the PMU data may be fed into, or input into, various applications (e.g., Wide Area Monitoring System (WAMS) and WAMS-related applications) that may utilize the more dynamic PMU data (explained further below).

In the example embodiment illustrated in FIG. 6, measurement device 620 may include a voltage sensor 602 and a current sensor 604 that feed data typically via other components, to, for example, a SCADA component 610. Voltage and current magnitudes may be measured and reported to a system operator every few seconds by the SCADA component 610. SCADA component 610 may provide functions such as data acquisition, control of power plants, and alarm display. SCADA component 610 may also allow operators at a central control center to perform or facilitate management of energy flow in the power grid system. For example, operators may use a SCADA component (e.g., using a computer such as a laptop or desktop) to facilitate performance of certain tasks such opening or closing circuit breakers, or other switching operations which might divert the flow of electricity.

In some examples, the SCADA component 610 may receive measurement data from Remote Terminal Units (RTUs) connected to sensors in the power grid system, Programmable Logic Controllers (PLCs) connected to sensors in the power grid system, or a communication system (e.g., a telemetry system) associated with the power grid system. PLCs and RTUs may be installed at power plants, substations, and the intersections of transmission and distribution lines, and may be connected to various sensors, including the voltage sensor 602 and the current sensor 604. The PLCs and RTUs may receive data from various voltage and current sensors to which they are connected. The PLCs and RTUs may convert the measured information to digital form for transmission of the data to the SCADA component 610. In example embodiments, the SCADA component 610 may also comprise a central host server or servers called master terminal units (MTUs), sometimes also referred to as a SCADA center. The MTU may also send signals to PLCs and RTUs to control equipment through actuators and switchboxes. In addition, the MTU may perform controlling, alarming, and networking with other nodes, etc. Thus, the SCADA component 610 may monitor the PLCs and RTUs and may send information or alarms back to operators over telecommunications channels.

The SCADA component 610 may also be associated with a system for monitoring or controlling devices in the power grid system, such as an AHM system. An AHM system may comprise one or more systems of computer-aided tools used by operators of the electric power grid systems to monitor and characterize the health of one or more assets of a power grid system and/or of the grid itself. SCADA component 610 may be operable to send data (e.g., SCADA data) to a repository 614, which may in turn provide the data to the AHM module 616. Other systems with which the AHM module 616 may be associated may comprise a situational awareness system for the power grid system, a visualization system for the power grid system, a monitoring system for the power grid system or a stability assessment system for the power grid system, for example.

SCADA component 610 may generate or provide SCADA data (e.g., SCADA data shown in FIG. 6) comprising, for example, real-time information (e.g., real-time information associated with the devices in the power grid system) or sensor information (e.g., sensor information associated with the devices in the power grid system) that may be used by the AHM module 616. The SCADA data may be stored, for example, in a repository 614 (described further below). In example embodiments, data determined or generated by the SCADA component 610 may be employed to facilitate generation of topology data (topology data is further described below) that may be employed by the AHM module 616 to monitor asset health.

The employment of current sensor 604 and voltage sensor 602 may allow for a fast response. Traditionally, the SCADA component 610 monitors power flow through lines, transformers, and other components relies on the taking of measurements every two to six seconds but cannot be used to observe dynamic characteristics of the power system because of its slow sampling rate (e.g., cannot detect the details of transient phenomena that occur on timescales of milliseconds (one 60 Hz cycle is 16 milliseconds). Additionally, although SCADA technology enables some coordination of transmission among utilities, the process may be slow, especially during emergencies, with much of the response based on telephone calls between human operators at the utility control centers. Furthermore, most PLCs and RTUs were developed before industry-wide standards for interoperability were established, and as such, neighboring utilities often use incompatible control protocols.

The measurement device 620 may also include one or more PMUs 606. A PMU 606 may comprise a standalone device or may be integrated into another piece of equipment such as a protective relay. PMUs 606 may be employed at substations and may provide input into one or more software tools (e.g., WAMS, SCADA, EMS, and other applications). A PMU 606 may use voltage and current sensors (e.g., voltage sensors 602, current sensors 604) that may measure voltages and currents at principal intersecting locations (e.g., substations) on a power grid using a common time source for synchronization and may output accurately time-stamped voltage and current phasors. The resulting measurement is often referred to as a synchrophasor (although the term “synchrophasor” refers to the synchronized phasor measurements taken by the PMUs 606, some have also used the term to describe the device itself). Because these phasors are truly synchronized, synchronized comparison of two quantities is possible in real time, and this time synchronization allows synchronized real-time measurements of multiple remote measurement points on the grid.

In addition to synchronously measuring voltages and currents, phase voltages and currents, frequency, frequency rate-of-change, circuit breaker status, switch status, etc., the high sampling rates (e.g., 30 times a second) provides “sub-second” resolution in contrast with SCADA-based measurements. These comparisons may be used to assess system conditions such as: frequency changes, power in megawatts (MW), reactive power in mega volt ampere reactive (MVARs), voltage in kilovolts (KV), etc. As such, PMU measurements may provide improved visibility into dynamic grid conditions and/or of asset health and may allow for real-time wide area monitoring of power system and/or asset health dynamics. Further, synchrophasors account for the actual frequency of the power delivery system at the time of measurement. These measurements are important in alternating current (AC) power systems, as power flows from a higher to a lower voltage phase angle, and the difference between the two relates to power flow. Large phase angle differences between two distant PMUs may indicate the relative stress across the grid, even if the PMUs are not directly connected to each other by a single transmission line. This phase angle difference may be used to identify power grid instability, and a PMU may be used to generate an angle disturbance alarm (e.g., angle difference alarm) when it detects a phase angle difference.

Examples of disturbances that might cause the generation of an angle disturbance alarm may comprise, for example, a line out or line in disturbance (e.g., a line out disturbance in which a line that was in service has now gone out of service, or in the case of a line in disturbance, in which case a line that was out of service has been brought back into service). PMUs 606 may also be used to measure and detect frequency differences, resulting in frequency alarms being generated. As an example, unit out and unit in disturbances may result in the generation of a frequency alarm (e.g., a generating unit was in service, but might have gone out of service, or a unit that was out of service has come back in to service—both may cause frequency disturbances in the system that may result in the generation of a frequency alarm). Still yet, PMUs 606 may also be used to detect oscillation disturbances (e.g., oscillation in the voltage, frequency, real power—any kind of oscillation), which may result in the generation of an alarm (e.g., oscillation alarm). Several other types of alarms may be generated based on PMU data from PMU based measurements. Although the disturbances mentioned (e.g., line in/out, unit in/out, load in/out) may result in angle or frequency disturbance alarms, an angle or frequency disturbance alarm might not necessarily mean that a particular type of disturbance occurred, only that it is indicative of that type of disturbance. For example, if a frequency disturbance alarm is detected, it might not necessarily be a unit in or unit out disturbance but may be a load in or load out disturbance. The measurement requirements and compliance tests for a PMU 606 have been standardized by the Institute of Electrical and Electronics Engineers (IEEE), namely IEEE Standard C37.118.

In the example of FIG. 6, one or more Phasor Data Concentrators (PDCs) 612 are shown, which may comprise local PDCs at a substation. Here, PDCs 612 may be used to receive and time-synchronized PMU data from multiple PMUs 606 to produce a real-time, time-aligned output data stream. A PDC may exchange phasor data with PDCs at other locations. Multiple PDCs may also feed phasor data to a central PDC, which may be located at a control center. Through the use of multiple PDCs, multiple layers of concentration may be implemented within an individual synchrophasor data system. The PMU data collected by the PDC 612 may feed into other systems, for example, a central PDC, corporate PDC, regional PDC, the SCADA component 610 (optionally indicated by a dashed connector), energy management system (EMS), synchrophasor applications software systems, a WAMS, the AHM module 616, or some other control center software system. With the very high sampling rates (typically 10 to 60 times a seconds) and the large number of PMU installations at the substations that are streaming data in real time, most phasor acquisition systems comprising PDCs are handling large amounts of data. As a reference, the central PDC at Tennessee Valley Authority (TVA), is currently responsible for concentrating the data from over 90 PMUs and handles over 31 gigabytes (GBs) of data per day.

In this example, the measurement device 620, the SCADA component 610, and PDCs/Central PDCs 612, may provide data (e.g., real-time data associated with devices, meters, sensors or other equipment in the power grid system) (including SCADA data and topology data), that may be used by the AHM module 616 for asset health monitoring. Both SCADA data and PMU data may be stored in one or more repositories 614. In some example embodiments, the SCADA data and PMU data may be stored into the repository 614 by the SCADA component 610, or by the PDC 612. In other embodiments, the AHM module 616 may have one or more components or modules that are operable to receive SCADA data and PMU data and store the data into the repository 614 (indicated by dashed lines). The repository 614 may comprise a local repository, or a networked repository. The data on the repository 614 may be accessed by SCADA component 610, the PDCs 612, other systems (not shown), and optionally by example embodiments of the AHM module 616. In example embodiments, the AHM module 616 may be operable to send instructions to one or more other systems (e.g., SCADA component 610, PDCs 612) to retrieve data stored on the repository 614 and provide it to the AHM module 616. In other embodiments, the AHM module 616 may facilitate retrieval of the data stored in repository 614, directly.

In example embodiments, the data stored in the repository 614 may be associated SCADA data and PMU data. The data may be indicative of measurements by measurement device 620 that are repeatedly obtained from a power grid system. In example embodiments, the data in repository 614 may comprise PMU/SCADA-based equipment data, such as, for example, data associated with a particular unit, line, transformer, or load within a power grid system (e.g., power grid system 600). The data may comprise voltage measurements, current measurements, frequency measurements, phasor data (e.g., voltage and current phasors), etc. The data may be location-tagged. For example, it may comprise a station identification of a particular station in which a power delivery device being measured is located (e.g., “CANADA8”). The data may comprise a particular node number designated for a location. The data may comprise the identity of the measure equipment (e.g., the identification number of a circuit breaker associated with an equipment). The data may also be time-tagged, indicating the time at which the data was measured by a measurement device. The PMU/SCADA-based equipment data may also contain, for example, information regarding a particular measurement device (e.g., a PMU ID identifying the PMU from which measurements were taken).

In example embodiments, the data stored in repository 614 may comprise not only collected and measured data from various measurement devices, the data may also comprise data derived from that collected and measured data. The data derived may comprise topology data (e.g., PMU/SCADA-based topology data), event data, and event analysis data, and AHM data (data generated by AHM module 616).

In example embodiments, the repository 614 may contain topology data (e.g., PMU/SCADA-based topology data) indicative of a topology for the power grid system 600. The topology of a power grid system may relate to the interconnections among power system components, such as generators, transformers, busbars, transmission lines, and loads. This topology may be obtained by determining the status of the switching components responsible for maintaining the connectivity status within the network. The switching components may be circuit breakers that are used to connect (or disconnect) any power system component (e.g., unit, line, transformer, etc.) to or from the rest of the power system network. Typical ways of determining topology may be by monitoring of the circuit breaker status, which may be done using measurement devices and components associated with those devices (e.g., RTUs, SCADA, PMUs). It may be determined as to which equipment has gone out of service, and actually, which circuit breaker has been opened or closed because of that equipment going out of service.

The topology data may be indicative of an arrangement (e.g., structural topology, such as radial, tree, etc.) or a power status of devices in the power grid system. Connectivity information or switching operation information originating from one or more measurement devices may be used to generate the topology data. The topology data may be based on a location of devices in the power grid system, a connection status of devices in the power grid system or a connectivity state of devices in the power grid system (e.g., devices that receive or process power distributed in throughout the power grid system, such as transformers and breakers). For example, the topology data may indicate where devices are located, and which devices in the power grid system are connected to other devices in the power grid system (e.g., where devices in the power grid system are connected, etc.) or which devices in the power grid system are associated with a powered grid connection. The topology data may further comprise the connection status of devices (e.g., a transformer, etc.) that facilitate power delivery in the power grid system, and the statuses for switching operations associated with devices in the power grid system (e.g., an operation to interrupt, energize or de-energize or connect or disconnect) a portion of the power grid system by connecting or disconnecting one or more devices in the power grid system (e.g., open or close one or more switches associated with a device in the power grid system, connect or disconnect one or more transmission lines associated with a device in the power grid system etc.). Furthermore, the topology data may provide connectivity states of the devices in the power grid system (e.g., based on connection points, based on busses, etc.).

In example embodiments, the repository 614 may contain a variety of event and event analysis data, which may be derived based on PMU data, and in some embodiments, other data as well (e.g., SCADA data, other measurement data, etc.). The data may comprise information regarding the health of one or more assets of the power grid system and/or of the grid itself. The various data stored in the repository 614, including equipment data, topology data, event data, event analysis data, AHM data, and other data, may be inputs into the various functionalities and operations that may be performed by the AHM module 616.

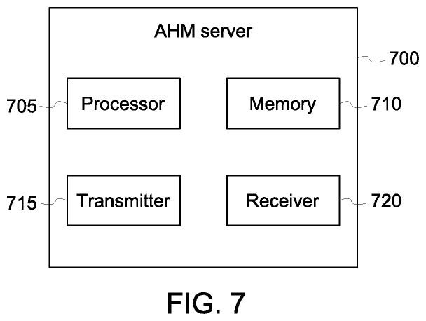

FIG. 7 illustrates an AHM server 700 according to an embodiment. For example, AHM server 700 may include a processor 705, a memory 710, a transmitter 715, and a receiver 720, to name just a few example components among many possibilities. For example, receiver 720 may receive data such as PMU data, SCADA data, weather data, and network topology data, as discussed above with respect to FIG. 2. Processor 705 may, for example, execute program code or instructions stored in memory 710 to process signals received by receiver 720 to identify one or more anomalies based on the input data to monitor the health of one or more power grid system assets and/or a health of the power grid system itself, for example. Transmitter 715 may transmit one or more messages, such as one or more alerts, based on calculations by processor 705. For example, if processor 705 identifies an anomaly such as an asset or sensor which has failed or is about to fail, an alert, such as a message, may be transmitted to computing device tasked with managing operation of that asset or sensor.

As will be appreciated based on the foregoing specification, one or more aspects of the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method for monitoring a health of a power system, the method comprising:
receiving input data from one or more sources, the input data comprising at least measurements of one or more power system assets from one or more phasor measurement units (PMUs);
detecting an anomaly within the power system based on the input data;
determining whether the anomaly comprises an asset anomaly of the one or more power system assets, wherein in response to determining that the anomaly comprises an asset anomaly:
characterizing the asset anomaly as comprising an equipment anomaly or a sensor anomaly; and
generating an alert indicating whether the asset anomaly comprises the equipment anomaly or the sensor anomaly based on the characterization.

2. The method of claim 1, further comprising determining that the anomaly comprises a grid anomaly in response to determining that the detected anomaly does not comprise an asset anomaly.

3. The method of claim 2, further comprising implementing a stress accumulator to measure an amount of stress on a power grid of the power system.

4. The method of claim 1, wherein the determination of whether the asset anomaly comprises the equipment anomaly or the sensor anomaly is based on individual channel correlation at a single PMU or a spatial correlation at multiple PMUs.

5. The method of claim 4, wherein in response to determining that the asset anomaly comprises an equipment anomaly, determining whether a corresponding anomaly signature occurs persistently within a time window and that a severity of the anomaly signature increases with time.

6. The method of claim 5, wherein in response to determining that the anomaly signature occurs persistently within the time window and increases with time, identifying an equipment pre-failure condition.

7. The method of claim 6, further comprising determining a remaining useful life of the equipment based at least in part on a measurement of a stress accumulator to measure an amount of stress on a power grid of the power system.

8. The method of claim 6, wherein in response to determining that the anomaly signature does not occur persistently within the time window or does not increase with time, identifying an equipment misoperation responsive to determining that the anomaly signature is triggered by a specific control operation condition.

9. The method of claim 4, wherein in response to determining that the asset anomaly comprises a sensor anomaly, determining whether there are approximately random transients within a short-term window.

10. The method of claim 9, further comprising determining whether the sensor anomaly comprises a sensor pre-failure condition or a sensor drifting anomaly based, at least in part, on the determination of whether there are the approximately random transients within the short-term window.

11. The method of claim 1, wherein the input data further comprises one or more of Supervisory Control and Data Acquisition (SCADA) data, weather data, or network topology data.

12. A system, comprising:
a receiver to receive input data from one or more sources, the input data comprising at least measurements of one or more power system assets from one or more phasor measurement units (PMUs);
a processor to:
detect an anomaly within the power system based on the input data;
determine whether the anomaly comprises an asset anomaly of the one or more power system assets, wherein in response to a determination that the anomaly comprises an asset anomaly:
characterize the asset anomaly as comprising an equipment anomaly or a sensor anomaly; and
generate an alert indicating whether the asset anomaly comprises the equipment anomaly or the sensor anomaly based on the characterization.

13. The system of claim 12, wherein the input data further comprises one or more of Supervisory Control and Data Acquisition (SCADA) data, weather data, or network topology data.

14. The system of claim 12, wherein the processor is to further determine that the anomaly comprises a grid anomaly in response to determining that the detected anomaly does not comprise an asset anomaly.

15. The system of claim 14, further comprising implementing a stress accumulator to measure an amount of stress on a power grid of the power system.

16. The system of claim 12, wherein the processor to determine whether the asset anomaly comprises the equipment anomaly or the sensor anomaly based on individual channel correlation at a single PMU or a spatial correlation at multiple PMUs.

17. An article, comprising:
a non-transitory storage medium comprising machine-readable instructions executable by one or more processors to:
access input data from one or more sources, the input data comprising at least measurements of one or more power system assets from one or more phasor measurement units (PMUs);
detect an anomaly within the power system based on the input data;
determine whether the anomaly comprises an asset anomaly of the one or more power system assets, wherein in response to a determination that the anomaly comprises an asset anomaly:
characterize the asset anomaly as comprising an equipment anomaly or a sensor anomaly; and
generate an alert indicating whether the asset anomaly comprises the equipment anomaly or the sensor anomaly based on the characterization.

18. The article of claim 17, wherein the input data further comprises one or more of Supervisory Control and Data Acquisition (SCADA) data, weather data, or network topology data.

19. The article of claim 17, wherein the machine-readable instructions are further executable by the one or more processors to determine that the anomaly comprises a grid anomaly in response to determining that the detected anomaly does not comprise an asset anomaly.

20. The article of claim 17, wherein the machine-readable instructions are further executable by the one or more processors to determine whether the asset anomaly comprises the equipment anomaly or the sensor anomaly based on individual channel correlation at a single PMU or a spatial correlation at multiple PMUs.
